(19) United States
(12) Patent Application Publication
(10) Pub. No.: US 2024/0326104 A1
(43) Pub. Date: Oct. 3, 2024

(54) BATTERY ELECTRODE MANUFACTURING DEVICE AND CLEAN ROOM STRUCTURE

(71) Applicant: APB CORPORATION, Tokyo (JP)

(72) Inventors: Hideaki HORIE, Tokyo (JP); Kenichiro ENOKI, Kyoto (JP); Yusuke NAKASHIMA, Kyoto (JP)

(21) Appl. No.: 18/573,460

(22) PCT Filed: Jun. 23, 2022
(86) PCT No.: PCT/JP2022/025010

§ 371 Date: Dec. 22, 2023

(30) Foreign Application Priority Data
Jun. 23, 2021 (JP) 2021-103780

(51) Int. Cl. B08B 5/02; H01M 4/04

(52) U.S. Cl. CPC B08B 5/026; H01M 4/0404

(57) ABSTRACT

A battery electrode manufacturing device (100) comprises: a chamber (110) whose inside (IN) is decompressed below atmospheric pressure, wherein a base film (31A) is conveyed to the inside (IN) of the chamber (110) via a load opening (112); and a clean room section (150) that provides a space, wherein the clean room section (150) is provided in the load opening (112) side outside (OU) of the chamber (110), wherein the internal (INa) of the space is pressurized above atmospheric pressure, wherein the base film (31A) is conveyed toward the load opening (112) in the space, and wherein the clean room section (150) supplies clean pressurized air (a1) toward the load opening (112).

### FIELD OF THE INVENTION

This invention relates to a battery electrode manufacturing device and a clean room structure.

### BACKGROUND ART

For example, Patent Document 1 discloses a substrate processing device comprising a chamber, a spin chuck, a chemical nozzle, an upper partition plate, and an FFU. The spin chuck holds the substrate horizontally within the chamber. The chemical liquid nozzle discharges a chemical liquid toward the substrate. The upper partition plate partitions the internal space above the substrate held by the spin chuck into an upper space and a lower space. The FFU supplies clean air from above the upper space to the upper space. With this configuration, this substrate processing device reduces contamination of the substrate by using an air flow that stops diffusion of a contaminated atmosphere.

### CITATION LIST

### Patent Literature

[Patent Reference 1] Japanese Unexamined Patent Application Publication No. 2015-230921

### BRIEF SUMMARY OF THE INVENTION

### Problems that Invention is to Solve

In general, the lithium-ion battery comprises a plurality of electrodes that have an active material layer formed on a current collector, wherein the electrodes are stacked via a separator. One idea is to manufacture such an electrode for lithium-ion batteries by supplying and fixing an active material onto a current collector in a chamber as described above. In this case, because extraneous materials may enter together with air through the opening for introducing the current collector into the chamber, there is a risk that the internal space of the chamber used for manufacturing electrodes may be contaminated. On the other hand, for example, the substrate processing device disclosed in Patent Document 1 is not designed to have an opening for introducing material to be manufactured into the chamber from the outside. Therefore, no measures are shown for extraneous suppressing materials from entering the chamber.

The present invention has been made in view of the above-mentioned problems and has an objective to provide a battery electrode manufacturing device and a clean room structure that can prevent extraneous materials from entering inside of the chamber.

### Means to Solve the Problems

In order to solve the above problems, a battery electrode manufacturing device of the present invention comprising: a chamber whose inside is decompressed below atmospheric pressure, wherein a base film is conveyed to the inside of the chamber via a load opening; and a clean room section that provides a space, wherein the clean room section is provided in the load opening side outside of the chamber, wherein the internal of the space is pressurized above atmospheric pressure, wherein the base film is conveyed toward the load opening in the space, and wherein the clean room section supplies clean pressurized air toward the load opening.

### Effects of the Invention

A battery electrode manufacturing device, and a clean room structure, according to this invention, can prevent extraneous materials from entering inside of the chamber.

### BRIEF DESCRIPTION OF DRAWINGS

FIG. 1 is a schematic cross-sectional view showing a schematic configuration of a unit cell according to an embodiment.

FIG. 2 is a schematic block diagram showing a schematic configuration of the manufacturing device according to the embodiment.

### DESCRIPTION OF EMBODIMENTS

Embodiments according to the present invention will be described in detail below based on the figures. It is noted that the present invention is not limited within this embodiment. Further, the constituent elements in the embodiments include those that can be easily replaced by those skilled in the art or those that are substantially the same.

### Embodiment

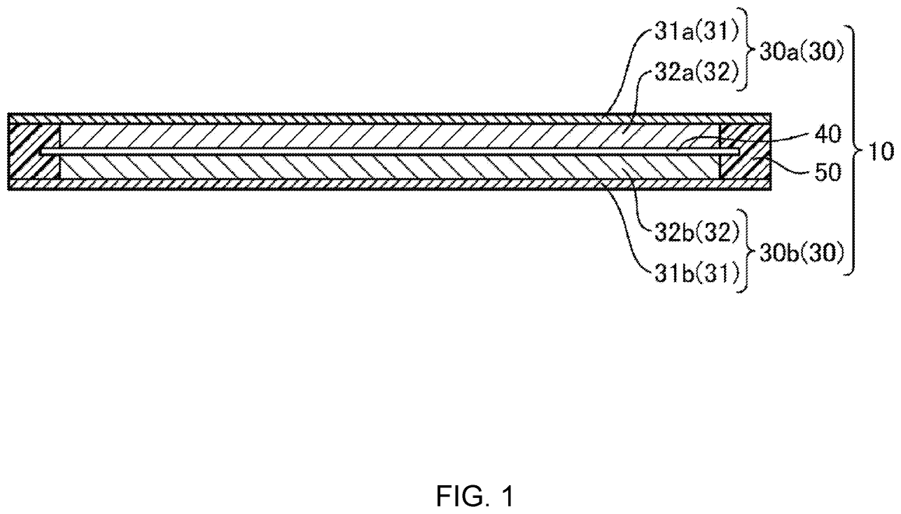

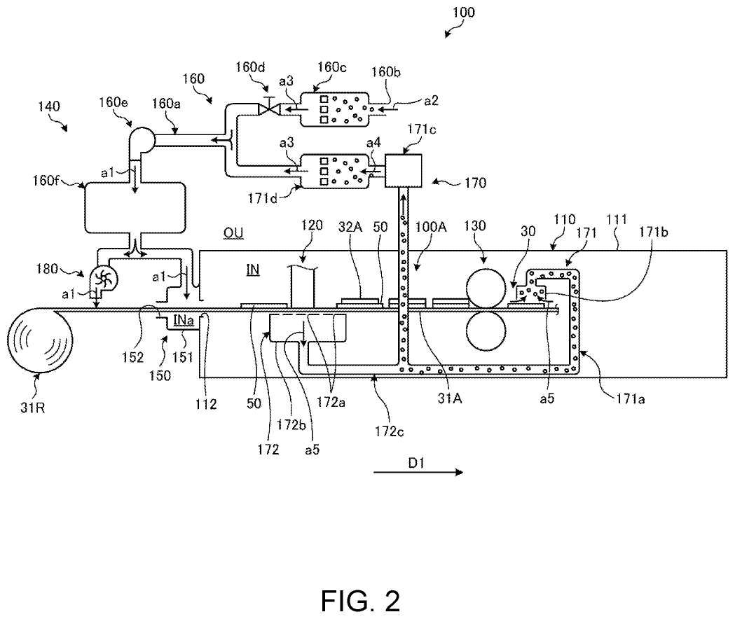

A manufacturing device 100 according to this embodiment shown in FIG. 2 is a battery electrode manufacturing device to manufacture an electrode 30 that is applied to a unit cell 10 shown in FIG. 1. Herein, first, the basic configuration of the unit cell 10 and the electrode 30 will be explained by referring to FIG. 1, and then the manufacturing device 100 will be explained in detail with reference to FIG. 2 and the like.

### <Unit Cell>

The unit cell (also called battery cell or single cell) 10 of this embodiment shown in FIG. 1 is a lithium-ion secondary battery, which is a type of non-aqueous electrolyte secondary battery. A lithium-ion secondary battery refers to a secondary battery that charges and discharges by the movement of lithium-ions between a cathode 30a and an anode 30b. Hereinafter, in a case when the cathode 30a and the anode 30b are referred to without distinction, they are referred to as an electrode 30.

The unit cell 10 comprises a cathode 30a, an anode 30b, a separator 40, and a frame member 50. The cathode 30a comprises a cathode current collector layer 31a and a cathode active material layer 32a. On the other hand, the anode 30b comprises an anode current collector layer 31b and an anode active material layer 32b. In the unit cell 10, the cathode current collector layer 31a, the cathode active material layer 32a, the separator 40, the anode active material layer 32b, and the anode current collector layer 31b, are stacked in this order. In the unit cell 10, the cathode current collector layer 31a and the anode active material layer 32b, are arranged as the outermost layers. Then, in the unit cell 10, the outer circumferences of the cathode active material layer 32a, the anode active material layer 32b, and the separator 40 are sealed by the frame member 50 at the edges of the cathode current collector layer 31a and the anode current collector layer 31b. And then electrolytic solution is sealed. In this state, in the unit cell 10, the separator 40 is sandwiched between the cathode active material layer 32a and the anode active material layer 32b, and the separator 40 functions as a partition between the cathode 30a and the anode 30b. The unit cell 10 can be used, for example, in the form of a battery pack whose voltage and capacity can be adjusted with an assembled battery that is made into a module by combining multiple batteries or by combining multiple such assembled batteries.

Hereinafter, when there is no need to specifically distinguish between “cathode current collector layer 31a” and “anode current collector layer 31b”, they may be simply referred to as “current collector layer 31”. Similarly, when there is no need to particularly distinguish and explain the “cathode active material layer 32a” and the “anode active material layer 32b,” they may be simply referred to as the “electrode active material layer 32.”

### <Specific Example of Cathode Current Collector>

As the cathode current collector constituting the cathode current collector layer 31a, a current collector used in a known lithium-ion cell can be used. For example, as the cathode current collector, a known metal current collector and a resin current collector composed of a conductive material and a resin (resin current collector described in JP 2012-150905 and WO 2015/005116, etc.), can be used. The cathode current collector constituting the cathode current collector layer 31a is preferably a resin current collector from the viewpoint of battery characteristics and the like.

Examples of metal current collectors include copper, aluminum, titanium, nickel, tantalum, niobium, hafnium, zirconium, zinc, tungsten, bismuth, antimony, alloys containing one or more of these metals, and one or more metal materials selected from the group consisting of stainless steel alloys. These metal materials may be used in the form of a thin plate, metal foil, or the like. Furthermore, a substrate, which is made of a material other than the above-described metal material, on which the above-mentioned metal material is formed by sputtering, electrodeposition, coating or the like, may be used as the metal current collector.

The resin current collector preferably contains a conductive filler and a matrix resin. Examples of the matrix resin include polyethylene (PE), polypropylene (PP), polymethylpentene (PMP), etc., but are not particularly limited. The conductive filler is not particularly limited as long as it is selected from materials having conductivity. For example, the conductive filler may be a conductive fiber having a fibrous shape.

The resin current collector may contain other components (dispersant, crosslinking accelerator, crosslinking agent, coloring agent, ultraviolet absorber, plasticizer, etc.) in addition to the matrix resin and the conductive filler. Further, a plurality of resin current collectors may be stacked and used, or a resin current collector and a metal foil may be stacked and used.

The thickness of the cathode current collector layer 31a is not particularly limited, but is preferably 5 to 150 μm. When a plurality of resin current collectors are stacked and used as the cathode current collector layer 31a, the total thickness after stacking is preferably 5 to 150 μm. The cathode current collector layer 31a can be obtained, for example, by molding a conductive resin composition obtained by melt-kneading a matrix resin, a conductive filler, and an optional filler dispersant into a film-shaped composition by a known method.

### <Specific Examples of Cathode Active Materials>

The cathode active material layer 32a is preferably a non-bound body of a mixture containing the cathode active material. Herein, a non-bound body means that the position of the cathode active material in the cathode active material layer is not fixed, and the cathode active materials and the cathode active materials and the cathode active material and the current collector are irreversibly fixed from each other. When the cathode active material layer 32a is a non-bound body, since the active materials cathode are not irreversibly fixed to each other, the interface between the cathode active materials can be separated without mechanical damages. Therefore, even when stress is applied to the cathode active material layer 32a, the transfer of the cathode active material can prevent destruction of the cathode active material layer 32a, which is preferable. The cathode active material layer 32a, which is a non-bound body, can be obtained by a method of changing the cathode active material layer 32a to the cathode active material layer 32a that contains a cathode active material and an electrolytic solution, and that does not contain a binder. Here, in this specification, the binder refers to an agent that cannot reversibly fix the cathode active material to each other and the cathode active material to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene-butadiene rubber, polyethylene and polypropylene may be exemplified. These binders are used by being in a dissolved or dispersed solvent, and are solidified by volatilizing and distilling off the solvent without the surface becoming sticky. Therefore, it is not possible to reversibly fix the cathode active materials, or the cathode active material and the current collector.

Examples of the cathode active material include a composite oxide of lithium and a transition metal, a composite oxide having two kinds of transition metal elements, a composite oxide having three or more kinds of metal elements and the like, but are not particularly limited.

The cathode active material may be a coated cathode active material in which at least a part of the surface is covered with a coating material containing a polymer compound. When the outer periphery of the cathode active material is covered with a coating material, volume change of the cathode is alleviated, and expansion of the cathode can be suppressed.

As the polymer compound constituting the coating material, those described as a resin for coating active material mentioned in JP 2017-054703 and WO 2015/005117 can be suitably used.

The coating material may contain a conductive assistant. As the conductive assistant, the same conductive filler contained in the cathode current collector layer 31a, can be suitably used.

The cathode active material layer 32a may contain adhesive resin. As the adhesive resin, those described as a mixture of a resin for coating non-aqueous secondary battery active materials, which is mentioned in Japanese Unexamined Patent Application, First Publication No. 2017-054703, and a small amount of organic solvent with adjusting the transition glass temperature below room temperature, and as an adhesive resin mentioned in Japanese Unexamined Patent Application, First Publication No. H10-255805 or the like, can be used. Here, the adhesive resin means a resin having pressure-sensitive adhesiveness (an adhering property obtained by applying a slight pressure without using water, solvent, heat, or the like) without solidifying even in a case where a solvent component is volatilized and dried. On the other hand, a solution-drying type binder for an electrode, which is used as a binding material, means a binder that dries and solidifies in a case where a solvent component is volatilized, thereby firmly adhering and fixing active materials to each other. As a result, the binder (the solution-drying type electrode binder) and the adhesive resin are different materials.

The cathode active material layer 32a may contain an electrolytic solution that contains an electrolyte and a non-aqueous solvent. As the electrolyte, those used in the known electrolytic solution can be used. As the non-aqueous solvent, those used in known electrolytic solutions (for example, phosphoric acid esters, nitrile compounds, etc., mixtures thereof, etc.) can be used. For example, a mixture of ethylene carbonate (EC) and dimethyl carbonate (DMC) or a mixture of ethylene carbonate (EC) and propylene carbonate (PC) can be used.

The cathode active material layer 32a may contain a conductive assistant. As the conductive assistant, a conductive material similar to the conductive filler contained in the cathode current collector layer 31a, can be suitably used.

The thickness of the cathode active material layer 32a is not particularly limited, but from the viewpoint of battery performance, it is preferably 150 to 600 μm, more preferably 200 to 450 μm.

### <Specific Example of Anode Current Collector>

As the anode current collector constituting the anode current collector layer 31b, one having the same structure as that described for the cathode current collector can be appropriately used. It also can be obtained by the same method. The anode current collector layer 31b is preferably a resin current collector from the viewpoint of battery characteristics and the like. The thickness of the anode current collector layer 31b is not particularly limited, but is preferably 5 to 150 μm.

### <Specific Examples of Anode Active Materials>

It is preferable that the anode active material layer 32b is a non-bound body of a mixture containing the anode active material. The reason why it is preferable that the anode active material layer is a non-bound body, is the same reason why it is preferable that the cathode active material layer 32a is a non-bound body. The method of obtaining the anode active material layer 32b which is a non-bound body, is the same as the method of obtaining the cathode active material layer 32a which is a non-bound body.

As the anode active material, for example, carbon-based materials, silicon-based materials, and mixtures thereof can be used, but there is no particular limitation.

The anode active material may be a coated anode active material, where at least a part of a surface of the coated anode active material is coated with a coating material containing a macromolecule compound. In a case where the outer periphery of the anode active material is covered by a coating material, the volume change of the anode is alleviated, and thus the expansion of the anode can be suppressed.

As the coating material, the same one as the coating material constituting the coated cathode active material can be suitably used.

The anode active material layer 32b contains an electrolyte and an electrolytic solution that contains a non-aqueous solvent. Regarding the composition of the electrolytic solution, an electrolytic solution similar to that contained in the cathode active material layer 32a can be suitably used.

The anode active material layer 32b may contain a conductive assistant. As the conductive assistant, a conductive material similar to the conductive filler contained in the cathode active material layer 32a can be suitably used.

The anode active material layer 32b may contain adhesive resin. As the adhesive resin, the same adhesive resin as the optional component of the cathode active material layer 32a can be suitably used.

The thickness of the anode active material layer 32b is not particularly limited, but from the viewpoint of battery performance, it is preferably 150 to 600 μm, more preferably 200 to 450 μm.

### <Specific Example of Separator>

Examples of the electrolyte held in the separator 40 include an electrolytic solution or a gel polymer electrolyte. The separator 40 ensures high lithium-ion conductivity by using these electrolytes. The form of the separator 40 includes, for example, a porous film made of polyethylene or polypropylene, but is not particularly limited.

### <Specific Example of Frame Member>

The frame member 50 is not particularly limited as long as it is made of a material that is durable against the electrolytic solution, but a polymer material is preferable, and a thermosetting polymer material is more preferable. The material constituting the frame member 50 may be any material as long as it has insulation properties, sealing properties (liquid tightness), heat resistance under the battery operating temperature, etc., and a resin material is suitably selected. Specifically, epoxy resins, polyolefin resins, polyester resins, polyurethane resins, polyvinidene fluoride resins, etc. may be used for the frame member 50.

### <Basic Configuration of Manufacturing Device>

Next, the schematic configuration of the manufacturing device 100 will be described with reference to FIG. 2. The manufacturing device 100 manufactures 30 the electrode described above. This manufacturing device 100 may be realized by being equipped with a battery manufacturing device that manufactures unit cells 10. It is noted that the current collector 31A described below constitutes the above-mentioned current collector layer 31 (cathode current collector layer 31a, anode current collector layer 31b). On the other hand, the active material 32A constitutes the electrode active material layer 32 (cathode active material layer 32a, anode active material layer 32b) described above.

Generally, when forming the electrode 30 by applying the powdered active material 32A onto the surface of the current collector 31A, which is a base film, under atmospheric pressure, air may remain inside the active material 32A. If press molding is performed on the active material 32A in this state, the compressed air will expand after the press is finished. This may cause the active material 32A to fly off or the surface of the active material 32A to become uneven.

On the other hand, the manufacturing device 100 of the present embodiment supplies the powdered active material 32A onto the strip-shaped current collector 31A, which is a base film, in the inside IN of the chamber 110, wherein the pressure of the chamber is reduced under the atmospheric pressure. Then, the electrode 30 is manufactured.

With this configuration, the manufacturing device 100 of the present embodiment prevents air from remaining inside the active material 32A and improves the uniformity of the electrode active material layer 32 formed on the current collector layer 31. Hereinafter, the specific configuration of each part of the manufacturing device 100 for realizing this, will be described below.

As explained above, in terms of the cathode 30a and the anode 30b, there are differences in materials constituting the current collector layer 31 (cathode current collector layer 31a, anode current collector layer 31b), and the electrode active material layer 32 (cathode active material layer 32a, anode active material layer 32b). However, there is no difference relating to the structure where an electrode active material layer 32 is electrically coupled to the surface of a current collector layer 31. Therefore, in the following description as well, unless there is a need to distinguish between manufacturing the “positive electrode 30a” and manufacturing the “negative electrode 30b,” they will simply be described as manufacturing the “electrode 30”.

Specifically, as shown in FIG. 2, the manufacturing device 100 comprises a chamber 110, an active material supplying device 120, and a roll press 130. A part of the active material supplying device 120 and the roll press 130 form an electrode forming part 100A. In terms of the manufacturing device 100, the electrode forming part 100A is a part of supplying the powdered active material 32A onto the current collector 31A to form the electrode 30. The electrode forming part 100A applies the active material 32A onto the current collector 31A, compresses the active material 32A to form the electrode active material layer 32, and forms the electrode 30. As described above, in this embodiment, the electrode forming part 100A is equipped in a reduced pressure environment inside IN of the chamber 110.

In addition, in the following description, as for the manufacturing device 100, the direction to which the current collector 31A is conveyed may be referred to as a “conveying direction D1.” The conveying direction D1 is typically along a substantially horizontal direction, and corresponds to a direction along the longitudinal direction of the strip-shaped current collector 31A. In terms of the manufacturing device 100, an active material supplying device 120 and a roll press 130 are arranged from the upstream side to the downstream side along the conveying direction D1.

The chamber 110 is a room whose inside IN is decompressed and maintained below atmospheric pressure. The chamber 110 of this embodiment handles the powdered active material 32A inside IN of the chamber. The chamber 110 is partitioned into a hollow shape by a partition wall 111, and functions as a room in which the inside IN space can be maintained at a pressure lower than the atmospheric pressure. The inside IN of the chamber 110 is decompressed below atmospheric pressure by a decompress pump. The pressure inside of the chamber 110 may be any value as long as it is decompressed below the atmospheric pressure. However, for example, it may be adjusted to be a low vacuum environment from atmospheric pressure to 1×10⁻¹ to 1×10⁻² Pa, or a high vacuum environment from 1×10⁻⁶ to 1×10⁻⁷ Pa, or an ultra-high vacuum more than that, or an extremely high vacuum of 10⁻⁸ to 10⁻⁹ Pa level. The standard atmospheric pressure is approximately 1013 hPa (approximately 10⁵ Pa). The chamber 110 holds the electrode forming part 100A in this inside IN space.

In terms of the chamber 110, a load opening 112 is formed in a partition wall 111. The load opening 112 is a substantially rectangular slit into which the strip-shaped current collector 31A can be carried (inserted) from the outside OU to the inside IN of the chamber 110. The load opening 112 penetrates the partition wall 111 along the conveying direction D1 in the upstream side of the conveying direction D1, and communicates between the outside OU and the inside IN of the chamber 110. Herein, the load opening 112 is formed in a size and shape that allows the current collector 31A to be carried from the outside OU to the inside IN while maintaining the reduced pressure environment in the inside IN of the chamber 110. In the chamber 110, the current collector 31A as a base film is carried into the inside IN through the load opening 112. Here, the direction where the current collector 31A is conveyed into the chamber 110, is along the conveying direction D1. For example, the strip-shaped current collector 31A is continuously supplied and carried into the inside IN through the load opening 112 while being pulled out from the current collector roll 31R provided under normal pressure in the outside OU of the chamber 110. The current collector 31A carried into the inside IN of the chamber 110 is conveyed along the conveying direction D1 by a conveyor, conveying rollers, etc. And the current collector 31A becomes individual current collectors 31A by cutting at appropriate timing in the process of manufacturing the electrode 30. Further, the current collector 31A carried into the inside IN of the chamber 110 is provided with the frame member 50 in the inside IN of the chamber 110. In this case, for example, the frame member 50 may be provided on the current collector 31A in the upstream of the active material supplying device 120 by using a frame member installation device or the like in the inside IN. Further, the frame member 50 may be provided on the current collector 31A between the active material supplying device 120 and the roll press 130, or may be provided on the current collector 31A after the roll press 130. FIG. 2 illustrates, as an example, a case where the frame member 50 is provided on the current collector 31A in the upstream of the active material supplying device 120.

The active material supplying device 120 is a device that supplies powdered active material 32A onto the strip-shaped current collector 31A. At least a part of the active material supplying device 120 is provided inside IN of the chamber 110 and constitutes the electrode forming part 100A together with the roll press 130. In the active material supplying device 120, at least a supply port and a shutter unit are arranged inside IN of the chamber 110 and constitute an electrode forming section 100A. The active material supplying device 120 supplies the powdered active material 32A onto the current collector 31A from the supply port by operating the shutter unit inside IN of the chamber 110.

The roll press 130 is a device that fixes the active material 32A, which was supplied onto the current collector 31A by the active material supplying device 120, onto said current collector 31A. The roll press 130 is provided inside IN of the chamber 110, and as described above, forms the electrode forming part 100A together with a part of the active material supplying device 120 (supply port, shutter unit, etc.). For example, the roll press 130 press-forms the active material 32A by sandwiching it and the current collector 31A by a pair of rollers, wherein the active material 32A is supplied and placed on the current collector 31A that is conveyed in the above-described process. Due to this, the roll press 130 fixes the active material 32A onto the strip-shaped current collector 31A.

The manufacturing device 100 configured as described above conveys the current collector 31A, which was carried into the inside IN of the chamber 110 through the load opening 112, to the electrode forming part 100A side. And the manufacturing device 100 supplies the powdered active material 32A to the conveyed strip-shaped current collector 31A from the supply port of the active material supplying device 120. In this case, in the manufacturing apparatus 100, opening and closing of the supply port by the shutter unit is adjusted so that a desired amount of the active material 32A, is supplied onto the conveyed current collector 31A. Then the manufacturing device 100 conveys the current collector 31A, on which the active material 32A was supplied, to the roll press 130. The active material 32A on the current collector 31A is press-molded by the roll press 130 and the active material 32A is fixed on the strip-shaped current collector 31A. Thereafter, the manufacturing device 100 can form the electrode 30 by appropriately cutting the strip-shaped current collector 31A in accordance with the size of the frame member 50. Herein, as a post-process after forming the electrode 30, the manufacturing device 100 further may continue to perform the process of manufacturing the unit cell 10 or an assembled battery by appropriately stacking the electrodes 30 (that is, cathode 30a and anode 30b), which were formed by the above-mentioned process.

As described above, the manufacturing device 100 of this embodiment forms the electrode 30 in a reduced pressure environment inside IN of the chamber 110. With this configuration, the manufacturing device 100 of the present embodiment can prevent air from remaining inside the active material 32A after supplying the powdered active material 32A onto the current collector 31A. Thereby, the active material 32A can be fixed on the current collector 31A. As a result, after pressing by the roll press 130, the manufacturing device 100 can prevent the active material 32A from flying off because of the remaining air and can prevent the surface of the active material 32A from becoming uneven.

The electrode 30 for lithium-ion batteries tends to exhibit more stable battery performance because the electrode active material layer 32 including the active material 32A, supplied on the current collector 31A, is uniformly formed. Therefore, as described above, the manufacturing device 100 of the present embodiment can prevent air from being included in the electrode active material layer 32 and can produce the electrode 30 with improved uniformity of the electrode active material layer 32. As a result, the unit cell 10 that can exhibit more stable performance can be manufactured.

The outline of the overall configuration of the manufacturing device 100 according to the present embodiment has been described above.

### <Clean Room Structure>

The manufacturing device 100 according to the present embodiment further has a clean room structure 140, as shown in FIG. 2. With this configuration, the manufacturing device 100 can suppress the inflow of extraneous materials into the inside IN of the chamber 110 through the load opening 112 and can manufacture the electrode 30 in a clean environment.

Specifically, the clean room structure 140 of this embodiment comprises a clean room section 150, an air supply device 160, a circulation device 170, and a cleaning device 180.

The clean room section 150 is a room to provide a space, wherein the clean room section 150 is provided in the load opening 112 side outside of the chamber 110, wherein the internal INa of the space is pressurized above atmospheric pressure, wherein the current collector 31A as a base film is conveyed toward the load opening 112. The clean room section 150 of this embodiment is provided adjacent to the load opening 112 outside OU of the chamber 110. The clean room section 150 is also called a dust-proof room or a clean air box, where air cleanliness is ensured. The clean room section 150 constitutes a space section where the internal INa is pressurized above atmospheric pressure. The clean room section 150 is partitioned into a hollow shape by a partition wall 151, which is provided around the load opening 112 so as to surround the load opening 112 outside OU of the chamber. The pressure of the internal INa of the clean room section 150 may be any value as long as it is pressurized above atmospheric pressure so as to prevent the air from flowing into the internal INa from the outside of the clean room section 150.

In the clean room section 150, the internal INa communicates with the inside IN of the chamber via the load opening 112. In the clean room section 150, an introduction opening 152 is formed in the partition wall 151. Like the load opening 112, the introduction opening 152 is a substantially rectangular slit that allows the strip-shaped current collector 31A as a base film to be introduced from the outside of the clean room section 150 into the internal INa. The introduction opening 152 penetrates the partition wall 151 of the clean room section 150 and communicates the outside with the inside INa of the clean room section 150. Herein, the introduction opening 152 is formed at a position facing the load opening 112 in the upstream side of the load opening 112, along the conveying direction D1 and penetrates the partition wall 151, along the conveying direction D1. With this configuration, in the clean room section 150, the current collector 31A can pass through the internal INa from the introduction opening 152 toward the load opening 112, along the conveying direction D1. For example, as described above, the strip-shaped current collector 31A is introduced into the internal INa of the clean room section 150 through the introduction opening 152 while being pulled out from the current collector roll 31R. And then, the strip-shaped current collector 31A passes through the internal INa of the clean room section 150 toward the load opening 112 and is continuously supplied and carried into the inside IN of the chamber 110 via the load opening 112. In the clean room section 150, a conveyance roller or the like for conveying the current collector 31A, may be provided in the internal INa.

The clean room section 150 supplies pressurized air (clean air) a1, which is purified and pressurized, toward the load opening 112. Herein, the clean room section 150 is filled with the clean pressurized air a1 supplied from the air supply device 160 or the circulation device 170 to the internal INa. As a result, in the clean room section 150, the space in the internal INa is maintained in a state where the pressure is higher than atmospheric pressure by the clean pressurized air a1 supplied to the internal INa.

The air supply device 160 is a device that cleans and pressurizes air (outside air) a2, which is taken from the outside OU of the chamber 110, and that supplies the air a2 to the internal INa of the clean room section 150 as the clean pressurized air a1.

Specifically, the air supply device 160 comprises an intake pipe 160a, an intake port 160b, a removal device 160c, an air supply valve 160d, a pressurizing device 160e, and a pressurizing tank 160f. The removal device 160c, the air supply valve 160d, the pressurizing device 160e, and the pressurizing tank 160f, are placed on the air supply flow path constituted by the intake pipe 160a.

The intake pipe 160a is a pipe that configures an air supply flow path for cleaning and pressurizing the air a2 outside OU of the chamber 110 and supplying the air as clean pressurized air a1 to the internal INa of the clean room section 150. One end of the intake pipe 160a connects to the partition wall 151 of the clean room section 150 and opens and communicates with the internal INa of the clean room section 150. On the other hand, the other end of the intake pipe 160a opens to the outside OU of the chamber 110, and forms the intake port 160b. The intake pipe 160a is provided with the removal device 160c, the air supply valve 160d, the pressurizing device 160e, and the pressurizing tank 160f in order from the upstream side to the downstream side along the supply direction (flow direction) of air a2 (in other words, in order from the intake port 160b side to the clean room section 150 side).

The intake port 160b is an opening for taking the air (outside air) a2 from the outside OU of the chamber 110 into the intake pipe 160a. As described above, the intake port 160b is configured such that the end of the intake pipe 160a on the side opposite to the clean room portion 150 side, opens to the outside OU.

The removal device 160c is a device that removes extraneous materials from the air a2 when the air a2 taken in from the outside OU through the intake port 160b, is supplied to the internal INa of the clean room section 150 as the clean pressurized air a1. Herein, the extraneous materials in the air a2 include various particles contained in the atmosphere, such as dust and fine particulate materials. The removal device 160c is configured by, for example, a filter device. The extraneous materials in the air a2 taken in from the intake port 160b and passed through the removal device 160c, are removed by the removal device 160c. As a result, the air a2 becomes clean air a3, and flows downstream through the intake pipe 160a.

The air supply valve 160d is a device that opens and closes the intake flow path, which is formed by the intake pipe 160a in the downstream side of the removal device 160c at the intake pipe 160a. The air supply valve 160d can switch states between a closed valve state that blocks the flow of clean air a3 in the intake pipe 160a and an open valve state that allows the flow of the clean air a3. For example, the air supply valve 160d is in the open valve state during normal operation of manufacturing the electrode 30 at the manufacturing device 100. On the other hand, the air supply valve 160d is in closed valve state, for when the example, the manufacturing device 100 stops manufacturing the electrode 30 due to maintenance or the like. Further, the air supply valve 160d can also be configured by, for example, a flow rate adjustment valve that can adjust the flow rate of clean air a3, in other words, the amount of intake of external air a2, flowing through the intake pipe 160a.

The pressurizing device 160e is a device that pressurizes the clean air a3 in the intake pipe 160a and pumps it into the internal INa of the clean room section 150 as clean pressurized air a1. The pressurizing device 160e is configured by, for example, a compressor, a pressurizing pump, or the like. When driven, the pressurizing device 160e takes air a2 from the outside OU of the chamber 110 into the intake pipe 160a through the intake port 160b. And then, the pressurizing device 160e pressurizes the air through the removal device 160c and the like and sends it into the internal INa of the clean room section 150 as clean pressurized air a1.

The pressurizing tank 160f is a buffer tank that temporarily receives the clean pressurized air a1 fed from the pressurizing device 160e in the intake pipe 160a. The pressurizing tank 160f, for example, suppresses the pulsation of the pressurized air a1 fed from the pressurizing device 160e, and stabilizes the pressure of the pressurized air a1, which is sent into the internal INa of the clean room section 150.

As mentioned above, the air supply device 160 takes air a2 from the outside OU into the intake pipe 160a through the intake port 160b when the pressurizing device 160e is driven. In this case, the air supply device 160 takes extraneous materials contained in the air a2 from the air intake port 160b along with the air a2. Then, after removing extraneous materials in the air a2 taken in from the intake port 160b by the removal device 160c, the air supply device 160 pressurizes the clean air a3, from which extraneous materials have been removed, by the pressurizing device 160e, and supplies it into the internal INa of the clean room section 150 as clean pressurized air a1. In this case, the air supply device 160 stabilizes the pressure of the pressurized air a1 in the pressurized tank 160f by passing through the pressurizing tank 160f and then supplies the clean air a3 to the internal INa of the clean room section 150. As a result, in the clean room section 150, the clean pressurized air a1 is supplied toward the load opening 112 in the internal INa, and the internal INa space is maintained in a state where the pressure is higher than atmospheric pressure.

Herein, in this air supply device 160, the intake pipe 160a branches between the pressurizing tank 160f and the clean room section 150 and is also connected to a cleaning device 180 described below. As a result, this air supply device 160 has a structure that also sends the clean pressurized air a1 to the cleaning device 180.

The circulation device 170 is a device that cleans and pressurizes the air a4 exhausted from the inside IN of the chamber 110 and circulates the air a4 into the internal INa of the clean room section 150 as the clean pressurized air a1. A part of the circulation device 170 of this embodiment is also used as the air supply device 160. Herein, the air supply device 160 and the circulation device 170 share the pressurizing device 160e and the pressurizing tank 160f.

The circulation device 170 of this embodiment comprises, for example, an exhaust device 171 and a suction stage 172.

The exhaust device 171 is a device that exhausts the air a5 inside IN of the chamber 110 to the outside OU. The exhaust device 171 typically exhausts not only the air a5 inside IN of the chamber 110 but also the fine particles of the active material 32A, which is scattered in the air a5 during the manufacture of the electrode 30, to the outside OU of the chamber 110.

Specifically, the exhaust device 171 comprises an exhaust pipe 171a, a suction port 171b, a suction device 171c, and a removal device 171d. The suction device 171c and the removal device 171d, are provided in the exhaust flow path constituted by the exhaust pipe 171a.

The exhaust pipe 171a is a pipe that constitutes an exhaust flow path for the exhausting air a5 from the inside IN of the chamber 110 to the outside OU of the chamber 110. Here, the exhaust pipe 171a constitutes a part of the circulation flow path in the circulation device 170, wherein the circulation flow path cleans and pressurizes the air a4 exhausted from the inside IN of the chamber 110, and circulates it to the internal INa of the clean room section 150 as clean pressurized air a1. The exhaust pipe 171a is provided across the inside IN and the outside OU of the chamber 110. The exhaust pipe 171a has one end led out from the inside IN to the outside OU of the chamber 110 and is connected to and merges with the intake pipe 160a between the air supply valve 160d on the intake pipe 160a and the pressurizing device 160e. On the other hand, the other end of the exhaust pipe 171a opens into the inside IN of the chamber 110 and forms the suction port 171b. The exhaust pipe 171a is provided with the suction device 171c and the removal device 171d in order from (in other words, in order from the suction port 171b side to the merging side with the intake pipe 160a) the upstream side to the downstream side along the exhaust direction (flow direction) of the air a5.

The suction port 171b is an opening for suctioning and taking the air a5 from the inside IN of the chamber 110 into the exhaust pipe 171a. As described above, the suction port 171b is configured such that the end of the exhaust pipe 171a, which is opposite to the merging portion with the intake pipe 160a, opens into the inside IN. Herein, the suction port 171b has a wide suction port shape so as to easily suck in and collect the microparticles of the active material 32A in the air a5 together with the air a5 inside of the chamber 110. In the example of FIG. 2, the suction port 171b is positioned downstream of the roll press 130 along the conveying direction D1 of the current collector 31A, wherein the conveying direction D1 is a direction from the active material supplying device 120 to the roll press 130, as an example.

The suction device 171c is a device that serves as a suction source for suctioning the air a5 inside IN of the chamber 110 from the suction port 171b. The suction device 171c is provided on the exhaust pipe 171a outside OU of the chamber 110. The suction device 171c is configured by, for example, a suction pump. Herein, the suction device 171c is provided separately from, for example, a vacuum pump that reduces the pressure inside IN of the chamber 110. The suction device 171c typically suctions by a negative pressure greater than the negative pressure, which is required to reduce the pressure below atmospheric pressure inside IN of the chamber 110.

The removal device 171d is a device that removes extraneous materials from the air a4 when the air a4, which is taken from the inside IN of the chamber 110 via the suction port 171b and exhausted to the outside OU, is circulated as clean pressurized air a1 to the internal INa of the clean room section 150. Here, the extraneous materials in the air a4 include, for example, microparticles of the active material 32A scattered in the air a5 inside IN of the chamber 110 during the manufacture of the electrode 30 described above. The removal device 171d, like the removal device 160c, is configured by, for example, a filter device. The air a4, which has been taken from the suction port 171b, exhausted to the external OU, and passed through the removal device 171d, has extraneous materials removed by the removal device 171d, becomes clean air (clean air) a3, and passes towards downstream through the exhaust pipe 171a.

The suction stage 172 is a device that is provided inside IN of the chamber 110 and assists in conveying the current collector 31A. The suction stage 172 places the current collector 31A, which is conveyed toward the electrode forming part 100A, and holds the current collector 31A by suction. The suction stage 172 places the current collector 31A on the upper surface of a surface plate (horizontal table) 172b, in which a large number of suction holes 172a are formed. The surface plate 172b has a hollow interior and a flat upper surface along which the current collector 31A is placed. A plurality of suction holes 172a are formed in the upper surface of this surface plate 172b and communicate with the inside of the surface plate 172b. The surface plate 172b is connected to and merges with the exhaust pipe 171a via a merging pipe 172c and is connected to the suction device 171c. Negative pressure is created inside of the surface plate 172b by driving the suction device 171c. Due to this negative pressure, the surface plate 172b maintains the posture of the current collector 31A, which is placed on the upper surface to the upper surface side, by sucking through the plurality of suction holes 172a.

As mentioned above, the circulation device 170 sucks the air a5 inside IN of the chamber 110 from the suction port 171b by driving the suction device 171c of the exhaust device 171. In this case, the exhaust device 171 also sucks the minute particles of the active material 32A, which is scattered into the air a5 during the manufacture of the electrode 30 from the suction port 171b along with the air a5. The circulation device 170 also sucks the air a5 inside IN of the chamber 110 from the suction hole 172a at the suction stage 172 by driving the suction device 171c of the exhaust device 171. Then, the circulation device 170 exhausts the air a5 sucked from the suction port 171b and the air a5 sucked from the suction hole 172a to the outside OU of the chamber 110 via the merging pipe 172c and the exhaust pipe 171a, respectively. In the circulation device 170, the removal device 171d removes and collects extraneous materials such as microparticles of the active material 32A in the air a4, which is exhausted from the inside IN of the chamber 110 in this manner. After this, the clean air a3 from which extraneous materials has been removed is merged with upstream of the pressurizing device 160e in the intake pipe 160a, and is circulated to the clean room section 150 side. The clean air a3, which is merged from the exhaust pipe 171a side of the circulation device 170 to the intake pipe 160a side of the air supply device 160, is pressurized by the pressurizing device 160e. And then, the air a3 is circulated to the internal INa of the clean room section 150 as clean pressurized air a1 via the pressurizing tank 160f. As a result, in the clean room section 150, the clean pressurized air a1 is supplied toward the load opening 112 in the internal INa, and the space in the internal INa is maintained in a state where the pressure is higher than atmospheric pressure.

In this way, in the intake pipe 160a of the air supplying device 160, in terms of the circulation device 170, the part downstream of the merging part with the exhaust pipe 171a also serves as a circulation flow path for circulating the air a4, which is exhausted from the inside IN of the chamber 110 to the internal INa of the clean room section 150 as clean pressurized air a1. In terms of the circulation device 170 of the present embodiment, the circulation flow path is composed of the merging pipe 172c of the suction stage 172, the exhaust pipe 171a of the exhaust device 171, and the part downstream of the merging part with the exhaust pipe 171a within the intake pipe 160a of the air supplying device 160.

The cleaning device 180 is a device that sprays air a1 onto the current collector 31A conveyed into the clean room section 150 to clean the current collector 31A, wherein the cleaning device 180 is provided in the upstream side from the clean room section 150 along the conveying direction D1 of the current collector 31A. The cleaning device 180 is also called an air shower that ensures air cleanliness. The cleaning device 180 is configured by, for example, a blower or the like. As described above, the cleaning device 180 is connected to the intake pipe 160a that branches between the pressurizing tank 160f and the clean room section 150. By making use of the cleaning device 180, the clean pressurized air a1 is supplied from the air supply device 160 or the circulation device 170, similarly to the clean room section 150. The cleaning device 180 then sprays the supplied clean pressurized air a1 onto the current collector 31A before it is conveyed into the clean room section 150 to clean the current collector 31A.

### <Operation of Manufacturing Device>

Next, by continuously referring to FIG. 2, the operation of the manufacturing device 100 configured as described above will be described.

The manufacturing device 100 forms the electrode 30 by supplying the powdered active material 32A onto the current collector 31A in the electrode forming part 100A inside IN of the chamber 110. Here, as described above, the manufacturing device 100 supplies a desired amount of active material 32A onto the current collector 31A using the active material supplying device 120 and supplies and fixes the active material 32A onto the current collector 31A using the roll press 130. As a result, the electrode 30, is formed. The manufacturing device 100 performs the above processing on the current collector 31A, which is conveyed into the inside IN of the chamber 110 from the load opening 112 and sequentially forms the electrodes 30.

In this case, the current collector 31A, which is conveyed to the load opening 112, reaches the load opening 112 via the cleaning device 180 and the clean room section 150 in this order, along the conveying direction D1. Herein, in the manufacturing device 100, the clean pressurized air a1 is supplied to the cleaning device 180 and the clean room section 150 from the air supply device 160 or the circulation device 170. Thereby, the manufacturing device 100 can clean the current collector 31A by spraying clean pressurized air a1 from the cleaning device 180 onto the current collector 31A before being conveyed into the clean room section 150. Further, in terms of the manufacturing device 100, the clean pressurized air a1 is supplied toward the load opening 112 in the internal INa. Towards the internal INa of the clean room section 150, where the internal INa is pressurized above atmospheric pressure by the clean pressurized air a1, the cleaned current collector 31A is conveyed through the introduction opening 152, and the conveyed current collector 31A is conveyed in the internal INa toward the load opening 112. In other words, the strip-shaped current collector 31A is pulled out from the current collector roll 31R, cleaned by the cleaning device 180, and then conveyed into the internal INa of the clean room section 150 through the introduction opening 152. Then, it passes through the internal INa toward the load opening 112 and is continuously supplied and carried into the inside IN of the chamber 110 via the load opening 112.

In addition, in the above case, the manufacturing device 100 may adjust the flow rate of the air a3 at the air supply valve 160d so as to ensure an appropriate supply amount between the supply amount (air supply amount) of pressurized air a1 supplied to the clean room section 150 by the air supply device 160 and the supply amount (circulation amount) of the pressurized air a1 supplied to the clean room section 150 by the circulation device 170.

Furthermore, in the manufacturing device 100 of the present embodiment, the load opening 112 as an inlet opening for introducing the current collector 31A into the inside IN of the chamber 110 is configured such that the load opening 112 allows the clean pressurized air a1 to flow from the internal INa of the clean room section 150 to the inside IN of the chamber 110. The manufacturing device 100 sucks some pressurized air a1 into the inside IN through the load opening 112 by utilizing the negative pressure inside IN while maintaining a reduced pressure environment inside IN of the chamber 110.

### <Functions and Effects of Embodiments>

Since the manufacturing device 100 and the clean room structure 140 described above have the clean room section 150, which is provided in the load opening 112 side outside OU of the chamber 110, it is possible to prevent extraneous materials from flowing into the inside IN of the chamber 110.

Herein, in this manufacturing device 100, in the internal INa of the clean room section 150 (here, provided adjacent to the loading opening 112), which is provided in the loading opening 112 side of the chamber 110 where the inside IN is depressurized under atmospheric pressure, the clean pressurized air a1 is supplied toward the load opening 112 and the internal INa is pressurized above atmospheric pressure. Due to this, in the manufacturing device 100, the internal INa of the clean room section 150 is pressurized higher than atmospheric pressure. Therefore, it is possible to prevent the air (outside air) from the outside OU of the chamber 110 from flowing into the internal INa of the clean room section 150, which is provided upstream of the load opening 112. With this configuration, the manufacturing device 100 can prevent air from the outside OU containing extraneous materials from directly flowing into the inside IN of the chamber 110 from the load opening 112. Then, the manufacturing device 100 can convey the current collector 31A, which is a base film, through the internal INa of the clean room section 150 and into the inside IN of the chamber 110 from the load opening 112.

As a result, the manufacturing device 100 takes the current collector 31A into the inside IN of the chamber 110 through the load opening 112 and then prevents the inside IN from being contaminated by extraneous materials contained in the air of the outside OU, even if the manufacturing device 100 does not have a large-scale structure such as installing the whole chamber 110 in a clean room and so on. Therefore, the manufacturing device 100 can manufacture the electrode 30 in a clean environment inside IN of the chamber 110.

In addition, the manufacturing device 100 and the clean room structure 140 described above can clean and pressurize the air a2 taken from the outside OU of the chamber 110 by the air supply device 160, and can supply the air as the clean pressurized air a1 into the internal INa of the clean room section 150. With this configuration, the manufacturing device 100 can maintain the internal INa of the clean room section 150 in a state where the internal pressure is higher than atmospheric pressure using the clean pressurized air a1, which is supplied to the internal INa. In conclusion, as described above, the manufacturing device 100 can appropriately suppress extraneous materials from flowing into the inside IN of the chamber 110.

In addition, the manufacturing device 100 and the clean room structure 140 described above can clean and pressurize the air a4 exhausted from the inside IN of the chamber 110 by the circulation device 170, and can circulate it to the internal INa of the clean room section 150 as the clean pressurized air a1. With this configuration, the manufacturing device 100 can efficiently supply the clean pressurized air a1 to the internal INa of the clean room section 150 by reusing the air a3 that has been exhausted from the inside IN of the chamber 110 and that has been purified by collecting extraneous materials from the air a4 that contains extraneous materials, which are scattered during the process of manufacturing the electrode, such as fine particles of the active material 32A. Thereby, the manufacturing device 100 can simultaneously collect extraneous materials scattered into the inside IN of the chamber 110 and pressurize the internal INa of the clean room section 150 by using the clean pressurized air a1. As a result, the manufacturing device 100 can suppress contamination of the inside IN of the chamber 110 by suppressing extraneous materials from flowing into the inside IN. In addition, the manufacturing device 100 can maintain the inside IN of the chamber 110 in a clean environment by collecting extraneous materials, such as microparticles of the active material 32A, which are scattered into the inside IN during the process of manufacturing the electrode 30. As a result, the manufacturing device 100 and the clean room structure 140 can manufacture the electrode 30 in a cleaner environment inside IN of the chamber 110.

Furthermore, the manufacturing device 100 and the clean room structure 140 described above can clean the current collector 31A before being introduced into the clean room section 150 by spraying air (clean pressurized air a1) onto the current collector 31A using the cleaning device 180, which is provided in the upstream side of the clean room section 150 along the conveying direction D1 of the current collector 31A. With this configuration, after removing the extraneous materials clinging to the current collector 31A, the manufacturing device 100 can convey the current collector 31A into the inside IN of the chamber 110 from the load opening 112 via the clean room section 150. As a result, the manufacturing device 100 can suppress extraneous materials from entering the inside IN of the chamber 110 together with the current collector 31A when the current collector 31A is conveyed into the inside IN of the chamber 110. Therefore, the manufacturing device 100 and the clean room structure 140 can reliably prevent more extraneous materials from flowing into the inside IN of the chamber 110.

Herein, the manufacturing device 100 and the clean room structure 140 described above can prevent extraneous materials from flowing into the inside IN of the chamber 110 used when manufacturing the electrode 30 by the electrode forming part 100A. As a result, the manufacturing device 100 and the clean room structure 140 can manufacture the electrode 30 in a clean environment inside IN of the chamber 110 IN, as described above. Therefore, for example, it is possible to produce the electrode 30 with desired performance more precisely.

### <Variation>

Note that the battery electrode manufacturing device and the clean room structure, according to the embodiments of the present invention described above, are not limited to the embodiments described above and various changes can be made within the scope of the claims.

In the above description, the electrode forming part 100A was described as forming the electrode 30 by directly supplying the powdered active material 32A to one surface of the current collector 31A as a base film. However, it is not limited to this way. For example, the electrode forming part 100A once supplies and fixes the active material 32A to a transfer film that is a base film different from the current collector 31A. And then, the electrode 30 may be formed by transferring and fixing the active material 32A, which is powder-molded into the transfer film, onto one surface of the current collector 31A. In this case, the electrode forming part 100A may include a transfer section for transferring the active material 32A from the transfer film to the current collector 31A. Moreover, the separator 40 may be a base film. In other words, the current collector 31A, the separator 40, or a transfer film can be used as the base film. If a base film is a transfer film, for example, by transferring the active material layer (electrode composition layer), which is formed on the film, onto a current collector as described above, it is possible to obtain an electrode for batteries.

In the above description, the base film, which was carried into the inside IN of the chamber 110 through the clean room section 150 and the load opening 112, was explained as the current collector 31A. However, the present invention is not limited thereto. As described above, the base film, which is carried into the inside IN of the chamber 110 through the clean room section 150 and the load opening 112, may be the separator 40, a transfer film, or the like.

In the above description, the frame member 50 was described as being provided to the current collector 31A in the inside IN of the chamber 110. However, it is not limited thereto and may be provided outside OU of the chamber 110. The frame member 50 may be installed to the current collector 31A outside OU, for example, in the upstream of the load opening 112, for example, in the upstream of the cleaning device 180, by using a frame member installation device or the like. In this case, the strip-shaped current collector 31A is carried into the inside IN from the load opening 112 via the clean room section 150 with the frame member 50, which was attached in the upstream of the cleaning device 180. In this case, the load opening 112 and the introduction opening 152 may be formed in a size and shape that allow the frame member 50 to enter together with the current collector 31A. Furthermore, the frame member 50 may be provided onto the current collector 31A in the downstream of the roll press 130 in the outside OU of the chamber 110 by using, for example, a frame member installation device or the like. Further, the battery electrode manufacturing device according to the present embodiment does not need to include a frame member installation device and a frame member installation process. For example, when a transfer film is used instead of the current collector 31A, the frame body 50 may be placed on the current collector 31A to which the electrode composition layer may be transferred, or the current collector 31A before the electrode composition layer is transferred.

In the above description, the air supply device 160 and the circulation device 170 have been described as being partially used at the same time. However, the invention is not limited thereto. The air supply device 160 and the circulation device 170 may be configured as separate systems. In the circulation device 170, a pressurizing device and a pressurizing tank are provided separately from a pressurizing device 160e and a pressurizing tank 160f on an exhaust pipe 171a, which is also a circulation pipe, and an exhaust pipe 171a may be provided separately from an intake pipe 160a and be connected to the clean room section 150. Further, the manufacturing device 100 does not need to have both the air supply and the device 160 circulation device 170. For example, the manufacturing device 100 may comprise one of the air supply devices 160 or the circulation device 170. Further, in the above description, the circulation device 170 was described as being configured to include the exhaust device 171 and the suction stage 172, but the present invention is not limited thereto.

Furthermore, in the above description, the cleaning device 180 has been described as being supplied with the clean pressurized air a1 from the air supply device 160 or the circulation device 170. However, it is not limited to this. The clean pressurized air a1 may be supplied from a system other than these. Further, the manufacturing device 100 does not need to include the cleaning device 180 in the first place.

The active material supplying device 120 described above may be entirely provided inside IN of the chamber 110.

Further, in the above description, the suction port 171b was described as being located in the downstream of the roll press 130 along the conveying direction D1. However, the suction port 171b is not limited thereto, and may be provided at another position.

Furthermore, in the above description, the suction device 171c of the exhaust device 171 was described as being provided separately from the decompression pump that depressurizes the inside IN of the chamber 110. However, the present invention is not limited to this, and one device may play both functions. In other words, the exhaust device 171 may be, for example, a vacuum pump that reduces the pressure inside IN of the chamber 110 (that is, it may also be used as a vacuum pump), or may be an exhaust device that has a suction source, which is separate from the vacuum pump. Furthermore, although the manufacturing device 100 has been described as being equipped with the suction stage 172, and the suction device 171c is also used for both the exhaust device 171 and the suction stage 172, the present invention is not limited to this. Even if the manufacturing device 100 comprises the suction stage 172, the suction device 171c does not need to serve for both the exhaust device 171 and the suction stage 172. For example, in the manufacturing device 100, as described above, when the suction source of the exhaust device 171 is also used as a decompression pump that decompresses the inside IN of the chamber 110, the suction source of the exhaust device and the suction device 171c of the suction stage 172 may be provided separately. Further, the manufacturing device 100 does not need to comprise the suction stage 172 in the first place.

The battery electrode manufacturing device and the clean room structure according to the present embodiment, may be configured by appropriately combining the constituent elements of the embodiments and variations described above.

What is claimed is:

1. A battery electrode manufacturing device comprising:
a chamber whose inside is decompressed below atmospheric pressure, wherein a base film is conveyed into the inside of the chamber via a load opening; and
a clean room section that provides a space, wherein the clean room section is provided in the load opening side outside of the chamber, wherein the internal of the space is pressurized above atmospheric pressure, wherein the base film is conveyed toward the load opening in the space, and
wherein the clean room section supplies clean pressurized air toward the load opening.

2. The battery electrode manufacturing device according to claim 1, further comprising:
an air supply device that cleans and pressurizes air, which is taken from the outside of the chamber, and that supplies the air to the internal of the clean room section as the clean pressurized air.

3. The battery electrode manufacturing device according to claim 1, further comprising:
a circulation device that cleans and pressurizes air exhausted from the inside of the chamber, and that circulates said air into the internal of the clean room section as the clean pressurized air.

4. The battery electrode manufacturing device according to claim 1, further comprising:
a cleaning device that sprays air onto the base film conveyed into the clean room section to clean, wherein the cleaning device is provided in the upstream side from the clean room section along the conveying direction of the base film.

5. The battery electrode manufacturing device according to claim 1, further comprising:
an electrode forming part that supplies powdered active materials onto the base film to form an electrode, wherein the electrode forming part is provided inside of the chamber.

6. A clean room structure comprising:
a clean room section that provides a space, wherein the clean room section is provided in a load opening side outside of a chamber whose inside is decompressed below atmospheric pressure, wherein a base film is conveyed to the inside of the chamber via the load opening, wherein the internal of the space is pressurized above atmospheric pressure, wherein the base film is conveyed toward the load opening in the space, and
wherein the clean room section supplies clean pressurized air toward the load opening.
